(19) United States
(12) Patent Application Publication
(10) Pub. No.: US 2026/0044899 A1
(43) Pub. Date: Feb. 12, 2026

(54) MULTI-INDUSTRY SIMPLEX USING TEMPORALLY EVOLVING PROBABALISTIC INDUSTRY CLASSIFICATION FOR DYNAMIC PORTFOLIO CREATION AND MAINTENANCE

(71) Applicant: O'Shaughnessy Asset Management, L.L.C., Stamford, CT (US)

(72) Inventor: Maksim PAPENKOV, Stamford, CT (US)

(73) Assignee: O'Shaughnessy Asset Management, L.L.C., Stamford, CT (US)

(21) Appl. No.: 19/290,887

(22) Filed: Aug. 5, 2025

Related U.S. Application Data
(60) Provisional application No. 63/681,491, filed on Aug. 9, 2024.

(51) Int. Cl. G06Q 40/06

(52) U.S. Cl. CPC G06Q 40/06

(57) ABSTRACT

Accurate industry classification is a critical tool for many asset management applications. While the current industry gold standard GICS (Global Industry Classification Standard) has proven to be reliable and robust in many settings, it has limitations that cannot be ignored. Fundamentally, GICS is a single-industry model, in which every firm is assigned to exactly one group—regardless of how diversified that firm may be. This approach breaks down for large conglomerates like Amazon, which have risk exposure spread out across multiple sectors. A solution for this failing is described wherein a probabilistic model that can flexibly assign a firm to as many industries as can be supported by the data is disclosed, specifically, a blended topic modeling and natural language processing-based approach that utilizes business descriptions to extract and identify corresponding industries. Each identified industry comes with a relevance probability, allowing for high interpretability and easy auditing, circumventing the black-box nature of alternative machine learning approaches.

### CROSS REFERENCE

This application claims the benefit of U.S. Provisional Patent Application No. 63/681,491, filed on Aug. 9, 2024. The entire contents of the provisional application are hereby incorporated by reference.

### TECHNICAL FIELD

The present invention relates to portfolio management in the field of finance, particularly an automated probabilistic method for industry classification that provides superior risk-management properties over the conventional human-constructed approach.

### BACKGROUND OF THE INVENTION

Risk management is a critical component of portfolio construction that significantly influences an investor's outcome. One of the primary dimensions of risk considered by portfolio managers is a firm's industry, which provides significant descriptive information regarding implied factors that influence the price movements of a stock.

The issue is that companies, like organisms, evolve over time. For example, Amazon® has evolved significantly beyond its original online bookstore to include ecommerce, cloud computing, film and television production, groceries, and many other categories. Each of these areas has risk, and thus it is important to model all of them—not just the single largest venture. The longer a portfolio ignores or fails to recognize/react to the evolution of its holdings the more unknown misrepresentation risk seeps into the portfolio.

The accumulation of such unknown risk is typically associated with holding conglomerate(s) that continuously enter/build/exit many different industry sectors. Unfortunately, under current risk-analysis protocols conglomerate(s) are treated as only operating in a single sector at a time. As a result, conglomerate(s) like Amazon® present financial professionals with an impossible task of constructing financial portfolios that include those conglomerate(s) but have known heterogeneous risk exposure (i.e., a portfolio where the risk to holdings is always known and the quantification of the risk is auditable).

In the past, financial advisors turned to the Global Industry Classification Standard (GICS), which assigns each company to exactly one industry sector/label—generally determined by the single sub-business within the conglomerate that is often the most recognizable and generates highest revenue. However, as outlined above, the more diversified a conglomerate becomes, the less its total risk can be accurately attributed to just that single sub-business. When asset managers operate off incomplete information—such as GICS—they introduce risk due to inaccurate industry attribution into the portfolio.

While GICS has proven to be a robust and reliable system for many decades, the ubiquity of multi-sector diversification by conglomerates requires an honest consideration of GICS' limitations, including but not limited to: (1) with only a single assigned label, GICS is one-dimensional resulting in an incomplete industry membership representation; (2) the assigned GICS label is almost-always static, as firms only change their assigned GICS industry in extremely rare situations (3) the reasons a GICS label is assigned is methodologically/subjectively opaque as the labels are manually assigned by individuals on a committee so it is difficult to determine why one classification was chosen over another or even confirm that similar firms are treated alike. As a result, GICS breaks down for large conglomerates, which have risk exposure spread out across multiple sectors. Simply put, the use of GICS unintentionally introduces undesirable misrepresentation risk into portfolios. The introduction of unknown risk by GICS also cannot be ameliorated by switching the label—unknown risk just comes from a different unknown source.

But how can all the risks to conglomerates be quantified in an auditable fashion?Most conglomerates are required by law to describe—in words—potential present and future risks to each of its individual business units. As a result, quantifying all the present/future disparate risks an individual conglomerate faces sounds simple—just quantify the disclosed risks. It is not simple.

A current popular natural language processing (“NLP”) approach to solve such a problem is to utilize large language models (“LLMs”)—like Chat GPT—to process text, however while this approach avoids the human-construction limitation of GICS, LLMs introduce just as many new issues of their own that prevent them from being a viable solution for portfolio managers, based on at least three reasons.

First, LLMs lack stability. It is undeniable that neural networks and LLMs have revolutionized the way natural language data is utilized for real-world applications, however, they are plagued by unexplainable fail states and hallucinations. Small perturbations in input data can result in significant prediction variation. Second, LLMs lack consistency as they struggle with the concept of time. That is an issue as portfolio construction/maintenance is a time series problem where risk(s) phase in/out and the recognition/reaction to nuanced changes that have an impact on the risk profiles of different holdings must be identified and reacted to at or near real time. Third, LLMs lack transparency. As outlined above, LLMs are impenetrable black boxes where it is impossible to determine why certain inputs resulted in certain outputs. It is widely understood that these issues are simply the cost of high-precision modeling, but it is important to recognize that these risks are much easier to ignore in applications where the implication of failure is much less severe—such as text summarization, chatbots, and machine translation. Most investors are not willing to tolerate such instability, inconsistency, inexplicability when failure causes a significant loss of their personal wealth.

As a result, we must turn to a wholly separate branch of NLP—topic modeling—which utilizes simpler and more interpretable architectures to provide a highly auditable and robust probabilistic industry classification solution. Although topic modeling is an older and less mechanically elaborate NLP framework, its lack of complexity is precisely the attribute that allows it to circumvent the limitations of LLMs while simultaneously avoiding the weaknesses of GICS.

### BRIEF SUMMARY OF THE INVENTION

To address these issues, applicant has developed “Multi-Industry Simplex” or “MIS” which is an NLP modeling pipeline that probabilistically assigns a firm to multiple industries based on text from business descriptions. MIS involves three distinct components that are necessary for successful and robust industry classification. The first is a text pre-processing approach in which industry-relevant keywords are manually identified through a human-in-the-loop workflow. The second is an ensemble machine learning architecture that leverages multiple topic models to convert keywords into industry-membership probabilities. The third is a post-processing algorithm that adjusts and corrects the model-estimated probabilities based on correlations and hierarchical relationships between industries. Unlike black-box LLM models, this approach relies on a much simpler mathematical structure, which allows for a particularly high level of human-interpretability and auditability, ensuring that robust model risk management is possible in practice. This empowers asset managers to easily diagnose and explain model fail states, such that they are able to rapidly iterate and improve the model to correct for any identified mistakes. In certain embodiments, the described invention may be used by asset managers to construct thematic portfolios and identify nearest neighbors of firms on the basis of multi-industry similarity.

The first step in constructing portfolios using the system and method disclosed herein involves gathering relevant data from various sources such as financial reports, market data, and company profiles. This data serves as the foundation for the subsequent analysis. The data harvesting may occur at set intervals or continuously. Furthermore, the harvesting may be based on a set of guardrails previously uploaded to a database by a financial advisor or an employee, contractor, or agent of the user or financial advisor. For example, the financial advisor may direct the system to harvest data from the Security and Exchange Commission's Electronic Data Gathering, Analysis, and Retrieval (“EDGAR”) system.

Once the data is collected, it undergoes preprocessing to ensure consistency and compatibility. This may involve standardizing data formats, cleaning missing values, and aligning data with the attributes used in the models. Preprocessing ensures that the data is ready for analysis and modeling. Again, how the system engages in pre-processing of the data will have been previously uploaded to a database by a financial advisor or an employee, contractor, or agent of the user or financial advisor.

With the preprocessed data in hand, the next step is to estimate the parameters of the models using Bayesian inference techniques. These parameters include the industry distributions and the company-specific distributions over these industry distributions. Bayesian inference incorporates prior knowledge and uncertainty into the parameter estimation process, leading to more robust estimates.

After estimating the parameters of the models, thematic industries or investment industries of interest are identified based on previous inputs from a financial advisor or an employee, contractor, or agent of the user or financial advisor. Industries may also be identified by market trends, investor preferences, or economic forecasts. For example, industries could include emerging technologies, sustainable energy, healthcare innovation, among others.

For each industry, criteria or characteristics previously uploaded by a financial advisor or an employee, contractor, or agent of the user or financial advisor are used to label or identify relevant companies. For example, for a “sustainable energy” industry, criteria may include companies involved in renewable energy production, energy-efficient technologies, and environmental sustainability.

Using the disclosed models and methods, the relevance of each company to the thematic industry of interest is assessed. Companies with higher probabilities of belonging to the thematic industry are considered more relevant by the system and method. This step helps filter and prioritize companies that align with the thematic focus of the portfolio.

Once the relevant companies are identified, portfolio construction begins. Portfolio optimization techniques are applied to construct portfolios that maximize exposure to the selected thematic industries while considering risk and return objectives previously uploaded by a financial advisor or an employee, contractor, or agent of the user or financial advisor. This involves selecting an appropriate mix of companies from the model outputs and weighing them based on their relevance to the thematic industries and their risk-return profiles.

In certain embodiments, the portfolios are periodically or continuously monitored and rebalanced to ensure that they remain aligned with the intended investment industries and objectives over time. Regular monitoring allows for adjustments based on changes in company characteristics, market conditions, and thematic trends.

Finally, the performance of thematic portfolios is evaluated using key metrics such as returns, risk-adjusted returns, tracking error, and thematic exposure. Performance is compared to benchmark indices or traditional diversified portfolios to assess the effectiveness of the thematic approach. Sensitivity analysis may also be conducted to understand the impact of different thematic industries, parameter choices, and portfolio construction methods on portfolio performance.

MIS provides a more comprehensive industry risk representation than GICS is capable of doing. MIS leverages advanced techniques in Bayesian Learning that analyze multiple large text datasets to probabilistically assign a firm to as many industries as are supported by the data. MIS manages model risk with a variety of rules-based safe-guards, ensuring high stability and interpretability. In certain embodiments, model training is done via a human-in-the-loop workflow to ensure that a practitioner's domain expertise is able to carefully guide the model towards an optimal solution that hedges against noisy and incomplete data. As outlined herein, MIS enables portfolio managers to better account for industry risks ignored by GICS, allowing them to provide a superior service to investors. Indeed, through this systematic process, financial advisors can construct portfolios, using the disclosed systems and methods, having known and auditable heterogeneous risk exposure at all times, thereby leveraging probabilistic industry classifications to capture underlying nuanced themes and trends driving investment opportunities in the market.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. The patent or application file contains at least one drawing executed in color. Copies of this patent or patent application publication with color drawing(s) will be provided by the Office upon request and payment of the necessary fee.

FIG. 1 shows an embodiment of a partial semantic-tree which could be used in the text pre-processing step described herein for the keyword “movie”.

FIG. 1A shows an exemplary embodiment of a keyphrase extraction for Amazon®.

FIG. 2 shows one embodiment of the architecture of a mixture model.

FIG. 3 shows how information flows at a high level in one embodiment of the disclosed systems and methods.

FIG. 4 shows how information flows at a high level in another embodiment of the disclosed systems and methods using Latent Dirichlet Allocation.

FIG. 4A shows how information flows at a high level in another embodiment of the disclosed systems and methods using a Hierarchical Dirichlet Process, also known as an Infinite Topic Model.

FIG. 4B shows how information flows at a high level in another embodiment of the disclosed systems and methods using a Correlated Topic Model.

FIG. 4C shows how information flows at a high level in another embodiment of the disclosed systems and methods using a Dynamic Topic Model.

FIG. 4D an embodiment of the architecture of the disclosed systems and methods.

FIG. 5 depicts an exemplary algorithm of one embodiment of the model disclosed herein.

FIG. 6 depicts one embodiment of an industry network colored by the relevant corporation's GICS sector designation.

FIG. 7 depicts one embodiment evidencing the twenty nearest neighbors to Amazon as determined using the disclosed system and methods.

FIG. 8 shows the hardware components of the system of the invention.

### DETAILED DESCRIPTION OF THE INVENTION

Various embodiments of the invention are described in detail below. Although specific implementations are described, this disclosure is provided for illustration purposes only. A person skilled in the relevant art will recognize that other components and configurations may be used without parting from the spirit and scope of this disclosure.

As disclosed herein, MIS or Multi-Industry Simplex, as the name implies, introduces an alternative approach in which a firm is probabilistically assigned to multiple industries, rather than just one. The benefits of this become obvious with just a single illustrative example—consider Amazon®. According to GICS, Amazon® is simply a “Broadline Retail” firm—which correctly attributes risk to the e-commerce portion of the business, but ignores other significant ventures of the firm. Beyond e-commerce, Amazon is also a massive player in the cloud computing industry, and additionally participates in streaming, artificial intelligence, grocery, consumer technology and other areas. By ignoring these additional ventures, a portfolio manager is not able to manage the full spectrum of industry risks, yielding a sub-optimal portfolio. MIS solves this precise problem with an interpretable NLP (natural language processing) methodology that identifies relevant industries from text data.

### Definitions

The term “industry” or “industries” means a category of products or services that address a common need. This includes physical commodities such as crops and coal, as well as abstract technologies such as computer vision and cybersecurity. In most settings, the term “industry” or “industries” and “theme” or “themes” can be used interchangeably.

The term “black-box” refers to modeling frameworks, such as large language modeling (LLMs) such as GPT. A model is a “black-box” if the individual model parameters are generally not human-explainable and if failure-states of the model cannot be easily attributed to a specific aspect of the model that can be readily modified. While black-box models are highly popular in many non-finance industries, this inability to diagnose the nature of a model's mistakes is non-tolerable in the context of portfolio management—as the cost of model failure can potentially be millions of investor dollars.

### Introduction

The invention provides a solution for the present need in the art for systems, methods, and devices for dynamic portfolio construction and maintenance with known heterogeneous risk exposure. In certain embodiments, the disclosed system and method may be used to construct thematic portfolios that gather a collection of companies involved in certain areas a financial advisor/professional predicts will generate above-market returns over the long term (e.g., thematic or nearest neighbor portfolios) based on monitoring of written information and disclosures of different portfolio holdings over a set timeframe. The monitoring may be continuous or at set intervals. The invention solves the prior art problems using a computer-based platform that is specially programmed to construct and maintain a dynamic portfolio that monitors changes in financial markets and/or heterogeneous risk exposure of the portfolio's holdings and proactively adjusts the holdings to minimize or remove unknown risks associated with the portfolio holdings.

The system synchronizes information from a server located at or connected to an advisor with the ever-changing market to chart a portfolio pathway that is most likely to minimize unknown risks of the portfolio's holdings while adhering to an industry previously specified by the financial advisor or an employee, contractor, or agent of the financial advisor. Such an approach requires a re-evaluation of the definition of “risk.”

Because the view of risk outlined in this application is connected to unknown or misrepresentation risk, instead of just the volatility of an investor's portfolio, the approach outlined differs significantly from current approaches to portfolio construction in the current age of conglomerates where a single portfolio holding faces vastly different risk points over different business segments. In traditional investment strategies, the system only assesses the risk of a single business unit of a holding. This oversimplification of a holding's risk profile introduces unknown risk to portfolio as current conglomerates face vastly different risks within different business units (e.g., Amazon's® consumer discretionary business does not face the same risks as its information technology business). Defining risk based on a single business unit within a conglomerate, which many companies are these days, guarantees that unknown misrepresentation risk will be introduced into a portfolio. Conversely, the approach outlined in this disclosure identifies all the nuanced risk a company faces, not just the risk to the largest revenue generating unit of the conglomerate. This optimal risk allocation in the present system is a significant advance to the present GICS model. Indeed, the disclosed system may dynamically adjust to different situations to minimize the potential unknown risk inherent when corporate conglomerates are included in portfolios.

A detailed discussion of the methods and systems of the invention is provided below. First, a system overview is outlined. Second, non-limiting examples are provided. Third, the way a user may interact with the system is identified. Fourth, discussion of the system components occurs. Fifth, a description of a cloud computing system, the preferred environment of this system, follows. Sixth, elements to further increase the performance of the systems and methods, which may be incorporated, are delineated.

### System Overview

A system for constructing and dynamically maintaining the makeup of a portfolio's holdings with known heterogeneous risk exposure is disclosed. The system includes a software application that obtains information about portfolio holdings and a processor and creates portfolios with known heterogeneous risk exposure based on the information obtained. Indeed, this approach may be used to create thematic and nearest neighbor portfolios that lack unknown or misrepresentation risk even when large conglomerates are included in the portfolio. In certain embodiments, the system constructs and dynamically maintains the most ideal portfolio from a given finite set of choices to cater to personal asset allocation choices with regard to thematic desires and risk tolerance in relation to portfolio construction/maintenance.

At a high-level, the disclosed invention extracts high-importance keywords from a large collection of text to identify the most relevant industries corresponding to a company. As with any data-oriented endeavor, the reliability of this industry classification method is highly dependent on the quality of data sourcing and the robustness of the text pre-processing methodology that creates a model input dataset. The approach described below leads to better curated model input data, which invariably leads to a more useful model that produces portfolios with known heterogeneous risk exposure.

### Data Sourcing

The system and methods described herein begin by deploying search strategies for written documents related to specific companies with the goal of obtaining as much diverse descriptive text data about a firm's business operations as possible, ideally from low-correlated sources. Such deployment may occur automatically. Regardless, the search strategies have been previously uploaded to the database by a financial advisor or an employee, contractor, or agent of the financial advisor. Such strategies may be operated continuously or at set intervals. Such search strategies may be location-based (e.g., search a company website for new documents), document-based (e.g., search for transcripts of earning calls related to a company), author-based (e.g., review articles, notes, social media posts from a specific individual), or combinations thereof. The documents identified pursuant to these search strategies form the preliminary dataset.

In certain embodiments, data sourcing rules, previously uploaded to the database by a financial advisor or an employee, contractor, or agent of the financial advisor, may be applied. For example, these rules may be: (1) a minimum document word count, (2) a minimum number of documents, (3) a minimum number of disparate locations of the documents, or (4) a combination thereof. Similarly, data sourcing rules related to the types of documents may also be employed. Examples of appropriate types of documents the system and method may utilize are: (1) 10-K business descriptions, (2) analyst-written business descriptions, (3) earnings call transcripts, (4) revenue segment data, (5) patent filings, (6) news or social media fees, and (7) other similar corporate documents/notes. The reason for such a rule in certain embodiments is the system and method seek out document(s) that provide sufficient evidence for classification.

In certain embodiments, trust-weighting(s), previously uploaded to the database by a financial advisor or an employee, contractor, or agent of the financial advisor, may be applied to the document. These trust-weighting(s) may be linked to each search strategy or document type.

For example, a document located in the Electronic Data Gathering, Analysis and Retrieval (“EDGAR”) of the Securities and Exchange Commission (“SEC”) may be assigned a higher trust weighting than a social media post discussing the company. Such trust-weighting(s) allow for the consideration of a greater number of document(s) from more diverse source(s) without compromising the integrity of the system and method. For example, the system and method could supplement a dataset with news headlines and social media feeds even though such data sources provide less structure and require additional considerations for stable integration.

Simply put, the use of the data sourcing rule(s) and trust-weighting(s) allow the system and method to concatenate multiple separate documents into a single object.

### Data Pre-Processing

The system and methods described herein applies text pre-processing to the preliminary dataset to create a model-input dataset. In certain embodiments, this pre-processing identifies keywords previously uploaded to the database by a financial advisor or an employee, contractor, or agent of the financial advisor to create a model-input dataset. The financial advisor or an employee, contractor, or agent of the financial advisor may in certain embodiments be a subject matter expert.

Such pre-processing may take the form of identifying/counting the number of keywords using a permutation-invariant multiset of words (e.g., a bag-of-words representation) to create a model-input dataset. Conversely, the pre-processing may utilize within-document context to extract meaning from text to summarize long documents into shorter versions that filter out irrelevant text (e.g., using a neural-net based natural language processor such as GPT) to create a model input dataset. Regardless, the purpose of pre-processing the preliminary dataset is to homogenize the model input data, which reduces the complexity of the input vocabulary and thus reduces the dimensionality of the model. The end result of this pre-processing is a model input data set comprising a collection of words such that each word is logically associated with only one industry.

Such pre-processing may include: (1) normalization, such as removing punctuation and converting all letters to lower-case, (2) stemming, where words are standardized to their root form such as making all words singular, (3) n-gram construction where words that satisfy a certain adjacency threshold previously uploaded to the database by a financial advisor or an employee, contractor, or agent of the financial advisor are combined to form compound words such as “machine” within two words of “learning” may become “machine learning”, (4) stop-word removal, such as elimination of non-descriptive words, (5) lemmatization which maps a set of words to a single keyword that represents an aggregate meaning such as designating “apple” and “banana” both become “fruit”, and (6) combinations thereof.

MIS leverages these tools to construct semantic trees that map a group of non-identical phrases to a single semantically-unambiguous keyphrase that summarizes the essence of that group, while clearly corresponding to a single product or service. In certain embodiments where lemmatization is used the set of words mapped to a single keyword may be synonyms, subcases of a general term, or combinations thereof. For example, clean-energy, green-energy, and green-power may all be mapped to renewable energy.

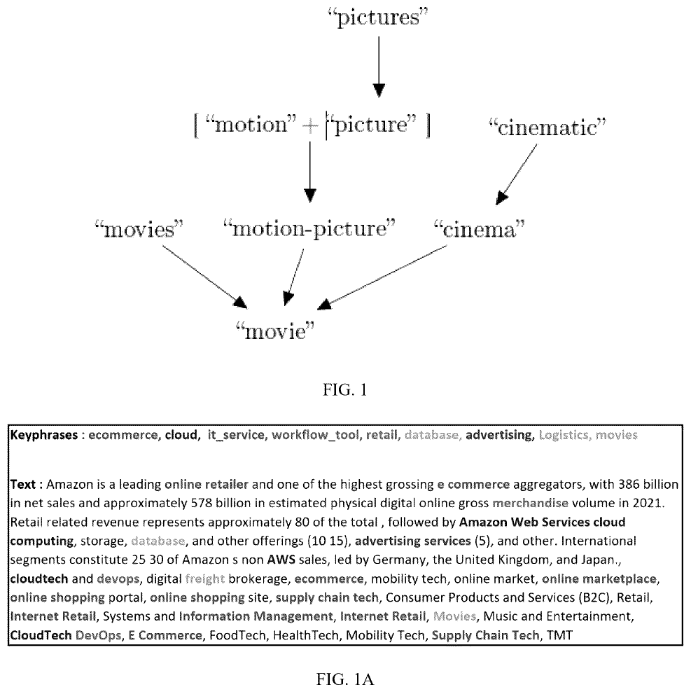

In certain embodiments, a semantic tree that summarizes how all the various tools operate together to homogenize the vocabulary is used. See, for example, FIG. 1 which is an exemplary embodiment of a partial semantic tree for the keyword “movie.” For this example bigram (“motion”+“picture”=“motion-picture”) was constructed, stemming (“cinematic”=“cinema”) was applied, lemmatization (“cinema”=“movie”) was used. As semantics is inherently subjective, the construction of such trees requires careful discretion and domain expertise. For example, a financial advisor or an employee, contractor, or agent of the financial advisor may construct over 300 semantic trees that map over 9000 n-grams to semantically-unambiguous keyphrases. FIG. 1A provides an illustrative example using Pitchbook's 2023 business description for Amazon® along with industry-related phrases concatenated to the end of the document.

It should be noted that FIG. 1 is a partial semantic tree. A full semantic tree may be vast with hundreds of nodes that account for subtle nuances in language, though regardless of scale, however, the logic doesn't need to be more complicated than what is described above. Regardless of size, the semantic tree utilized by the system or method will have previously uploaded to the database by a financial advisor or an employee, contractor, or agent of the financial advisor. By using such a human in the loop approach the system and method will not blindly adhere to a black-box modelling approach, but rather will leverage human expertise to guide the model towards a solution that best meets the financial advisor's specific needs.

In certain embodiments the magnitude the increase/decrease of the prevalence of key words and key phrases that appear in documents linked to specific firms/companies is calculated and tracked over a time horizon previously uploaded by the financial advisor or an employee, contractor, or agent of the financial advisor. Such calculation/tracking may be used by the systems or methods to predict the direction of different firms/companies and rebalance portfolios based on rules previously uploaded by the financial advisor or an employee, contractor, or agent of the financial advisor. For example, if Amazon announces an intention to divest its WholeFoods® business the systems and methods may appropriately adjust the risk portfolio of Amazon® based on the upcoming divestiture date (e.g., the portion of risk Amazon® is subject to in the grocery market will move downward in a linear or non-linear fashion as the divestiture date approaches).

In certain embodiments, semantics may be color coded or highlighted different colors. The highlighted/colored text may allow raw n-grams to be replaced with their associated semantically-unambiguous keyphrases (which each correspond to a single color). The remaining text may be discarded. As a result, the result of data pre-processing is a preliminary data object in a bag-of-words form {ecommerce, ecommerce, retail, cloud, cloud, . . . } which will be the input format necessary to fit a topic model.

### Industry Identification Via Topic Modeling

A topic model identifies clusters of frequently co-occurring words within a corpus. For sufficiently clean data, these clusters are often human-interpretable and share a common topic (hence the name). As a result of pre-processing, the preliminary data object is in a bag-of-words form containing semantically-unambiguous phrases relating to products and services. MIS defines each word-cluster as an MIS-industry (e.g. a cluster including “computer-vision”, “machine-learning”, and “natural-language-processing” implies artificial intelligence). Once a topic model is trained, MIS can represent each input document as a probability distribution over topics, which in this case each correspond to an industry. Thus, each business description may be represented as an industry-mixture, allowing efficient/systematic identification of industry relevance for firms.

For example, consider the text from FIG. 1A, which would be processed as FIG. 3A. The only knowledge that the topic model has about a firm is contained within the input text, so careful data sourcing and pre-processing is helpful to guarantee a reliable output. Next, the components and framework of the topic model are discussed.

The data within the topic model includes a corpus containing m-many business descriptions wherein X={x₁ . . . xₘ}. Each business description (xₘ) is represented as a bag-of-words containing Nₘ-many keyphrases, wherein x_{m,n} is the n-th keyphrase of the m-th business description.

As discussed below, MIS is adapted to fit a topic model with K-many topics, such that each is a distribution over a vocabulary of V-many distinct keyphrases. In certain embodiments, MIS ignores probabilities below some threshold previously uploaded by the financial advisor or an employee, contractor, or agent of the financial advisor, such that each MIS-industry corresponds to only a subset of the keyphrases. The notation Δ^{V} represents a simplex, which is a discrete probability distribution over V-many categories. The k-th MIS-Industry is defined over V-many keyphrases as φₖ∈Δ^{V}. Again, for each input firm with business description xₘ MIS estimates an industry-mixture over our K-many MIS-industries. Again, in certain embodiments, MIS ignores probabilities below a threshold previously uploaded by the financial advisor or an employee, contractor, or agent of the financial advisor, such that each firm is only associated with a small subset of the most probable industries. This results in θₘ∈Δ^{K} where the industry-mixture corresponds to the m-th firm's business description.

Finally, one additional technical detail that is relevant for parameter inference is that each individual keyphrase in each individual bag-of-words is assigned to a single MIS-industry via an industry-index. As will be discussed later, this latent variable is helpful in inferring φₖ and θₘ. As a result, z_{m,n} is the industry index for keyphrase x_{m,n} such that z_{m,n}∈{1, 2, . . . , K}.

The modeling framework of the system and method utilizes Bayes learning theory, which incorporates information contained in dataset X and prior parameter θ to estimate a posterior distribution as Formula 1 below:

$${\underbrace{P ( θ \vert X )}}_{posterior} ∝ {\underbrace{P ( X \vert θ )}}_{likelihood} {\underbrace{P ( θ )}}_{prior} \qquad Formula 1$$

Bayesian learning theory is a powerful framework used in statistics and machine learning for modeling uncertainty and making predictions based on data. In Bayesian learning, probability is interpreted as a measure of belief or uncertainty. Instead of treating probabilities as frequencies of events in the long run (as in frequentist statistics), Bayesians view probabilities as expressing subjective degrees of belief. At its core, Bayesian learning revolves around updating beliefs about the world as evidence accumulates.

Bayesian learning employs Bayes' theorem, which describes how to update prior beliefs in light of new evidence. Mathematically, it is represented as Formula 2 below:

$$P ( A \vert B ) = \frac{P ( B \vert A ) P ( A )}{P ( B )} \qquad Formula 2$$

Where, P(A|B) is the probability of event A given B (the posterior probability), P(B|A) is the probability of event B given A (the likelihood), P(A) and P(B) are the probabilities of events A and B respectively (the prior and marginal probabilities). Bayesian learning starts with a prior probability distribution representing existing beliefs about the parameters or hypotheses of a model before observing any data. This prior can be based on previous experience, expert knowledge, or assumptions. The likelihood function captures how the observed data depend on the parameters of the model. It represents the probability of observing the data given different values of the parameters. After observing data, Bayes' theorem is used to update the prior beliefs, yielding the posterior distribution. The posterior distribution combines the prior beliefs with the observed data, providing a refined estimate of the parameters or hypotheses. In Bayesian learning, parameter estimation involves computing the posterior distribution over the parameters given the observed data. This posterior distribution encapsulates uncertainty about the parameters and allows for probabilistic inference. Bayesian learning also facilitates model selection by comparing different hypotheses or models using their posterior probabilities. This allows for principled decisions about which model best explains the observed data, while accounting for model complexity and uncertainty. Bayesian learning naturally accommodates sequential updating of beliefs as new data becomes available. This iterative process allows for continual refinement of one or multiple models over time, making it suitable for online learning and adaptive systems.

As a person of ordinary skill in the art would understand, multiple topic model architectures are available. For example, the use of Latent Dirichlet Allocation (LDA) is discussed below.

### Model Fitting

Within a large corpus of text (multiple sources across multiple years) MIS is adapted to identify stable clusters of keywords as “industries”, which reflect the choices made during data pre-processing. A key feature of MIS is that due to the transparency and simplicity of the underlying mathematical process, the financial advisor or an employee, contractor, or agent of the financial advisor can bring forward certain industries to appear in a system or method with 100% certainty by adding sufficient keywords to the pre-processor. Similarly, the financial advisor or an employee, contractor, or agent of the financial advisor can merge redundant industries and eliminate irrelevant industries by a similar mechanism. This type of model control is not possible within a black-box LLM such as GPT, highlighting the benefits of utilizing the disclosed model architectures. Indeed, the model architectures may employ: (1) human-in-the-loop learning, (2) non-parametric modeling, (3) model ensembling, (4) temporal updating, or (5) combinations thereof.

Human-in-the-Loop Learning is a process via which a model is iteratively improved in practice involves continuous human feedback. Specifically, human-in-the-loop is a workflow in which a model is fit, then a human audits the output to identify mistakes, readjusts the data pre-processor to address these mistakes, and finally re-fits the model. In practice, this process involves re-fitting the model a number of times where small improvements at each iteration lead to massive cumulative gains over time. Further, as the model iteratively improves, a momentum effect emerges in which convergence is sped up, and the audit process becomes more efficient.

Non-parametric modeling assists with the difficult decision that a practitioner must address which is the number of industries that appear in the final model. In certain embodiments, rather than set this number manually, MIS utilizes non-parametric Bayesian Learning to automatically “discover” the optimal number of industries during the model fitting process. This ensures that an industry appears if and only if sufficient evidence of its existence is supported by the data. This improves the identified industries by confirming they are highly reliable and that the model has minimal sensitivity to noise.

Model ensembling promotes maximal model consistency and stability. In certain embodiments, rather than use a single model, MIS utilizes an ensembling approach in which it fits a large set of these non-parametric models in parallel, and only utilize industries for which MIS identifies sufficient evidence of correlation across the ensemble. This high threshold for evidence significantly mitigates model risk.

Finally, temporal updating highlights a significant benefit of the Bayesian approach. Specifically, that the model can dynamically evolve as the portfolio holdings evolve over time, rather than needing to refit a new model from scratch at set intervals. MIS can utilize an existing model, and “update” parameters with new dataset, ensuring both interpretability and consistency on a time-series basis. This mechanism can even be set up in a manner such that the number of industries changes from year to year, allowing new industries to naturally emerge and outdated industries to expire. While black-box LLMs such as GPT also have mechanisms to update over time, they do not have temporal transparency, and it is often not clear which information was digested at which time-step, which is a significant problem for portfolio management applications in which are driven by time-sensitive signals.

### Embeddings

In certain embodiments MIS employs industry relevance scores also known as “embeddings”. In general NLP parlance, an “embedding” is a numeric representation of text within a high-dimensional mathematical space. For MIS, the input text is converted into an embedding vector for which each dimension corresponds to one of the underlying industries “discovered” by the model during the fitting step. The value of a vector at a specific dimension corresponds to the industry relevance of a particular firm. For example, if Tesla has a value of 1.0 along the dimension associated with the “automobile” industry, then MIS interprets this as saying that Telsa is an automobile firm with 100% certainty—which highlights the interpretability of MIS. As a contrast, for an LLM such as GPT, a similar interpretation of the embedding vector is not possible—as each dimension of the embedding space is an abstract combination of inputs that is inherently a black box. When estimating embeddings, one must carefully mange both false-positive and false-negative risk using a set of adjustments such as: (1) high evidence filters, (2) multi source validation, (3) multi-source blending, (4) appended implied industries, (5) adjusted correlated industries, or (6) combinations thereof.

In certain embodiments, high-evidence filters are used. High-evidence filter is used to knock out certain industries below a certain threshold previously uploaded by a financial advisor or an employee, contractor, or agent of the financial advisor. For example, in certain embodiments any industry with a relevance score of less than 5% may be ignored, creating a sparse embedding in which each firm only has a small subset of retained industries. This reduces false-positive risk.

In certain embodiments, multi-source validation is used. In such embodiments, firms may have multiple independent sources of text for MIS to digest. multi-source validation is used to knock out certain industries below a certain threshold previously uploaded by a financial advisor or an employee, contractor, or agent of the financial advisor. For example, in certain embodiments a industry that has high relevance (e.g., greater than 5%) across multiple sources is retained, if multiple sources are available. Again, this reduces false-positive risk.

In certain embodiments, multi-source blending is used. In such embodiments, once all low-evidence industries have been eliminated, MIS blends the embeddings of the individual sources together to construct a single composite representation of the firm. In some embodiments where not all documents are equally reliable, MIS uses “credibility-weighting”, previously uploaded by a financial advisor or an employee, contractor, or agent of the financial advisor, to ensure that more reliable documents have greater influence than those we believe to contain more noise.

In certain embodiments, appended implied industries are used. In such embodiments, some industries are sub-industries of more broadly defined super-industries (for example “computer vision” is a subset of “artificial intelligence”), so MIS appends super-industries that are not explicitly mentioned in cases where only the sub-industry is discussed in the text. This reduces false-negative risk. As with the data pre-processing step, all sub/super industry relations are determined by-hand at the discretion of a domain expert (i.e., they have been previously uploaded by a financial advisor or an employee, contractor, or agent of the financial advisor).

In certain embodiments, adjusted correlated industries are used. In such embodiments, some industries are intrinsically tied together, and thus MIS can boost the relevance of some pairs of co-occurring industries. For example, if a firm's embedding is 50% “gold” and 50% “mining”, MIS can reasonably infer that this is a pure-play gold-mining company. Thus, MIS can adjust the relevance scores to update the embedding to be 100% “gold”, 100% “mining”, which is a better representation of the firm. Like implied industry relations, correlated industry relations are also determined by a domain expert.

### Mixture Models

Because of the nuance of the English language that make up the model input data, mixture models are used. Mixture models are probabilistic models used to represent the idea that each data point can belong to multiple groups or categories simultaneously, with varying degrees of membership. In certain embodiments, mixture models can be thought of as probabilistic generalizations of the classical machine learning tool K-Means Clustering.

The core machinery of a mixture-model is the categorical distribution, which represents random variable z as of one of K-many possible values based on probability distribution θ∈Δ^{K} (called the “simplex”). As an illustrative example, the fairness of a coin can be modeled with Formula 3 below where K=2, the fairness of a six-sided dice can also represent, and with K=6:

$$z ∼ {Categorical}_{K} ( z \vert θ ) : \{ \begin{matrix}P ( z = 1 \vert θ ) = {θ}_{1} \\ … \\ P ( z = K \vert θ ) = {θ}_{K}\end{matrix} \qquad Formula 3$$

To make this a proper probabilistic model, the system and method may parameterize the randomness of parameter θ with a Dirichlet distribution, which captures the uncertainty of the system/method's uncertainty as Formula 4:

$$θ \sim {Dirichlet}_{K} ( θ \vert β ) = \frac{Γ ( {Σ}_{i = 1}^{K} {β}_{i} )}{{Π}_{i = 1}^{K} Γ ( {β}_{i} )} \cdot {\prod }_{i = 1}^{K} {θ}_{i}^{{β}_{i - 1}} \qquad Formula 4$$

These components are combined to construct a mixture model defined by the following generative process of Formulas 5-7 below, where N is the total number of firms (each denoted as yₙ to avoid confusion with xₙ in the next section).

$${y}_{n} ∼ P ( {y}_{n} \vert {μ}_{{z}_{n}} ) \qquad Formula 5$$

$${z}_{n} ∼ {Catagorical}_{K} ( {z}_{n} \vert θ ) \qquad Formula 6$$

$$θ ∼ {Dirichlet}_{K} ( θ \vert β ) \qquad Formula 7$$

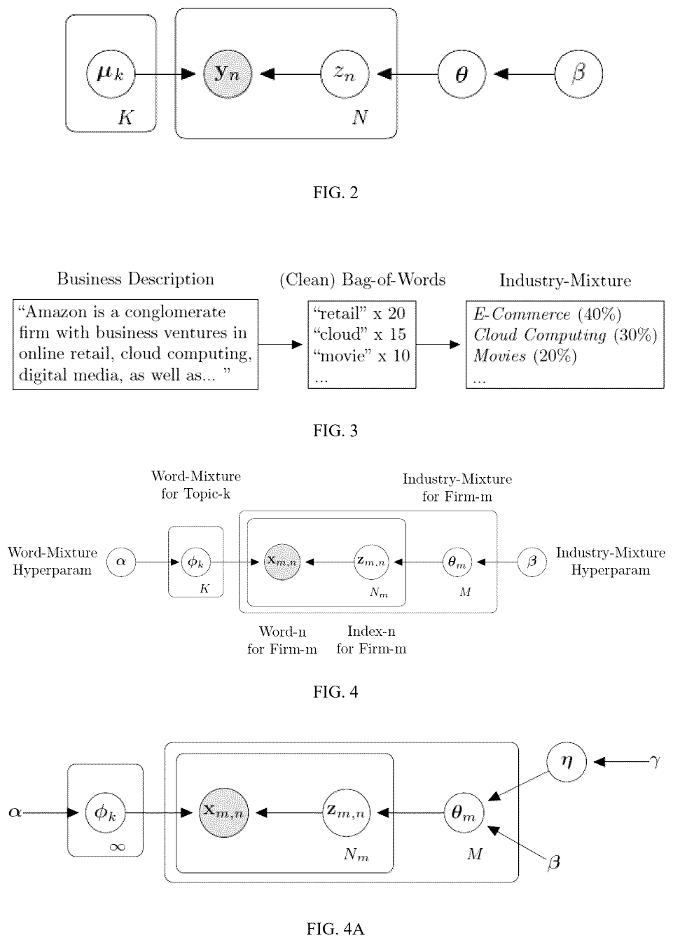

In such embodiments, zₙ∈{1, 2, . . . , K} is a group index, so observation yₙ simply belongs to the group-zₙ. Here μ_{z}_{ₙ} is a parameter that describes the nature of that particular group. FIG. 2 summarizes the full architecture.

Once this model is fit, the system or method can estimate the probability of group membership for a particular observation P(zₙ|xₙ) using Bayes Theorem, which may yield something like the following (assuming K=2)

$$P ( {z}_{n} \vert {y}_{n} ) = [ 0.95 , 0.05 ] ↔ 95 \% probability {y}_{n} belongs to group = 1 , 5 \% otherwise$$

As can be seen, the above can be used to generalize as simple or sophisticated a model architecture as necessary.

The described systems and methods employ at least two levels of mixture-models. For example, the mixture model may posit the following architecture: (1) each firm is an industry-mixture, and (2) each industry is a word-mixture.

Remember, a mixed-membership model is used for data in which each observation is a collection of elements (in this case a BOW) such that each element belongs to a group. Mixed-membership models have prolific applications to various fields including document classification, social network analysis, and genetics. When mixed-membership models are applied to text, they are commonly referred to as “topic models”, the simplest of which is Latent Dirichlet Allocation (LDA).

FIG. 3 depicts how information flows in the described systems and methods. Specifically, the system and method begins with raw business description, then is converted it to a clean BOW via text pre-processing, and finally the model estimates an industry-mixture. Each industry is a word-mixture and may take on the following exemplary form.

$$E - Commerce = [ {}^{″} {retail}^{″} ( 30 \% ) , {}^{″} {online}^{″} ( 28 \% ) , {}^{″} supply - {chain}^{″} ( 25 \% ) , … ]$$

The model architecture utilized herein requires at least three dimensionalities.
M: total number of firms/companies; each business description has Nₘ-many words.
K: total number of industries that are modeled (specified by the user).
V: total vocabulary size in pre-processed text.
   As discussed above, with these, MIS may define the following variables
xₘ: the m-th firm's business description represented as a BOW (e.g. x₁={“bank”, “finance”, . . . }).
x_{m,n}: the n-th word in the m-th firm's BOW business description.
z_{m,n}: the industry-index for word x_{m,n} (such that z_{m,n}∈{1, 2, . . . , K}).
θₘ∈Δ^{K}: the industry-mixture of the m-th firm.
φₖ∈Δ^{V}: the word-mixture of the k-th industry.

In certain embodiments employing LDA, two additional hyperparameters are used
α: a control on φₖ that influences the number of keyphrases associated with each MIS-industry.
β: a control on θₘ that influences the number of MIS-industries associated with each industry-mixture.

As a result, the disclosed systems and methods may utilize the above described Latent Dirichlet Allocation generative process of Formulas 8-11.

$${x}_{m , n} ∼ {Catagorical}_{V} ( {x}_{m , n} \vert {ϕ}_{{z}_{m , n}} ) \qquad Formula 8$$

$${z}_{m , n} ∼ {Catagorical}_{K} ( {z}_{m , n} \vert {θ}_{m} ) \qquad Formula 9$$

$${θ}_{m} ∼ P ( {Industry}_{k} \vert {Firm}_{m} ) = {Dirichlet}_{K} ( {θ}_{m} \vert β ) \qquad Formula 10$$

$${ϕ}_{k} ∼ P ( {Word}_{k} \vert {Industry}_{m} ) = {Dirichlet}_{V} ( {ϕ}_{k} \vert α ) \qquad Formula 11$$

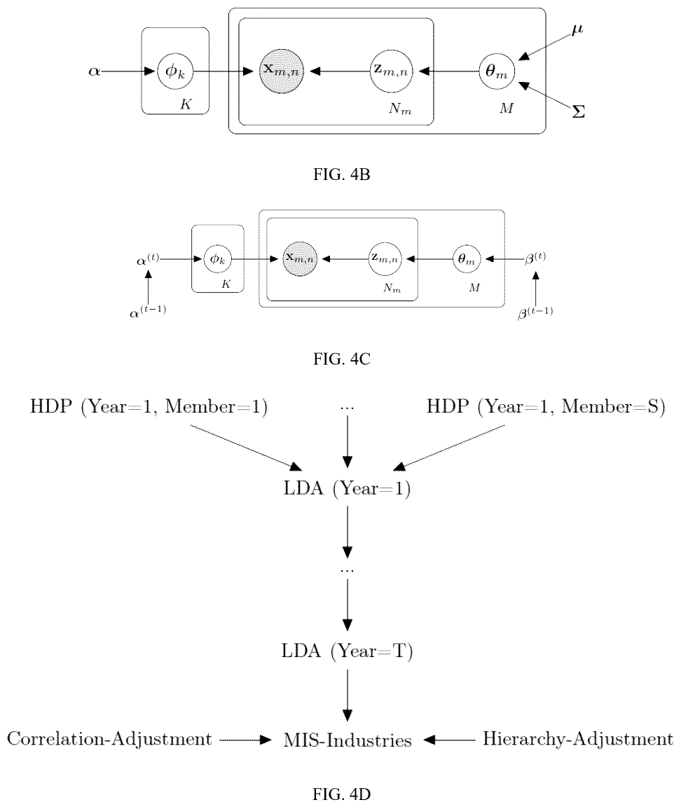

The appeal of this architecture is that it fits both the industry-mixtures and the word-mixtures simultaneously, thereby yielding an internally-consistent representation of a market. As a result, a conglomerates complete risk profile identifying all of the risk points of the conglomerate's disparate business units can be quantified. Furthermore, as each parameter in this model is simply a probability of something belonging to a particularly group, this model is fully auditable/interpretable. FIG. 4 depicts how the LDA architecture can convert information from written descriptions to probabilities.

In certain embodiments, the mixed membership model is evaluated as part of the disclosed systems and methods. One tool to evaluate the quality is perplexity, which measures goodness-of-fit. A lower perplexity indicates a better sample fit, which may provide guidance for further calibrating the text pre-processor and for hyperparameter tuning. Perplexity for estimated θ and φ may be defined as Formulas 12-14 below where count (w_{m,v}) is used as the count of the v-th word of the vocabulary for the m-th company.

$$Perp ( {θ}_{1 : M} , {ϕ}_{1 : K} ; {x}_{1 : M} ) = exp ( - \frac{{\sum }_{m = 1}^{M} log P ( {θ}_{1 : M} , {ϕ}_{1 : K} ; {x}_{m} )}{{\sum }_{m = 1}^{M} {N}_{m}} ) \qquad Formula 12$$

$$log P ( {θ}_{1 : M} , {ϕ}_{1 : K} ; {x}_{m} ) = {\sum }_{v = 1}^{V} count ( {w}_{m , v} ) \cdot log [ {\sum }_{k = 1}^{K} {ϕ}_{k , v} \cdot {θ}_{m , k} ] \qquad Formula 13$$

$$log P ( {θ}_{1 : M} , {ϕ}_{1 : K} ; {x}_{m} ) = {\sum }_{k = 1}^{K} log P ( {ϕ}_{x} ) + {\sum }_{m = 1}^{M} [ log P ( {θ}_{m} ) + {\sum }_{i = 1}^{{N}_{m}} ( log P ( {θ}_{m , {z}_{m , i}} + log {ϕ}_{{z}_{m , i} {w}_{m , i}} ) ] \qquad Formula 14$$

It should be noted that a higher numerical perplexity may correspond to a less human interpretable model, so care must be applied to the utilization of this metric. However, perplexity can be used to compare two models to evaluate if one is a better fit than the other, with a lower score being more optimal. Another tool for model evaluation is coherence.

As can be seen above, there are precisely two mechanisms via which the function defined by Formulas 12-14 above can be improved. First, for a company/firm, the financial advisor or an employee, contractor, or agent of the financial advisor must have chosen and/or uploaded high-likelihood industries that maximize P(industry=z_{m,i}|firm=m). Second, the financial advisor or an employee, contractor, or agent of the financial advisor must have chosen and/or uploaded high-likelihood keywords that maximize P(word=w_{m,i}|industry=z_{m,i}).

The key here is that these two objectives are mutually exclusive, thus during inference the financial advisor or an employee, contractor, or agent of the financial advisor must balance a delicate trade-off. Selecting fewer industries for a firm, requires those industries represent a broader set of words. Conversely, by selecting fewer words for an industry, more industries are required to represent a single firm. These competing goals encourage peaky distributions to form for both θs and φs, which causes both the posteriors for the industry-mixtures and the word-mixtures to appear approximately sparse. Thus, under the disclosed systems and methods, most firms will be part of a small number of industries, and most industries will be defined by a small number of words. This significantly helps with interpretability in practice—the users can instantly understand why the system or method assigned the firm/company the label it did.

In certain situations where LDA is utilized, it may be unclear how to reasonably select K, which represents the total number of MIS-Industries. In such embodiments, an elegant approach is to automate the selection of K with Bayesian Non-Parametrics, which is a modeling framework that “discovers” an optimal K during inference, such that there are precisely as many dimensions as can be supported by the dataset. In such embodiments, K may be set to: (1) infinity; (2) a computational setting where the number of industries is treated as a latent random variable that can be inferred from a data sample so as to leverage statistical methods in order to design algorithms that can run in finite-time to estimate K from a dataset; (3) phenomenological setting, where the number of industries at time-t are treated as a stochastic process that is non-constant over time, which allows this perspective to evolve the number of industries within a changing market over time so new industries emerge and obsolete industries disappear; or (4) a combination thereof.

Once K is selected, a person of ordinary skill in the art may utilize Hierarchical Dirichlet Process (HDP) as opposed to LDA. HDP is an extension of LDA. In some embodiments of HDP, although K may be defined as infinite in theory, a trained topic model K will move K towards a finite integer.

As outlined above, a person of ordinary skill in the art could extend LDA to a non-parametric setting as a Hierarchical Dirichlet Process which employs Formulas 8-11 discussed above as K approach infinity but includes the additional variable f associated with a global set for topics, where η˜Dirichlet_{K}(η|γ). This is very similar to LDA, though with an additional variable η that is associated with a global set for topics, which is controlled by one extra hyperparameter: γ as a control on the final estimated K. As a result, a higher γ leads to a higher final K). Simply put, θₘ represents the distribution of MIS-industries for a single firm, while η represents the distributions of MIS-industries over an entire universe. For example, broad industry descriptions like banking will include many firms, while niche industries like lumber milling only include a few. This process is summarized in FIG. 4A.

Another limitation of LDA is the implicit assumption that all industry categories are independent, which may not always be the case. For example, many pairs of industries are correlated—such as artificial-intelligence which often co-occurs with robotics or oil-drilling which often co-occurs with petrochemicals. To avoid this assumption, in certain embodiment, a Correlated Topic Model (CTM) is used. Most regard CTM as identical to LDA apart from one key modification—it replaces the single-variable Dirichlet distribution on θₘ with a two-variable Logistic Normal distribution. The Logistic Normal distribution involves sampling a Multivariate Gaussian variable and transforming it into a simplex as outlined below:

$$θ ∼ LogicalNormal ( μ , Σ ) ⇔ η ∼ Normal ( μ , Σ ) ; θ = \frac{exp {η}_{i}}{\sum exp {η}_{i}}$$

As a result, Dirichlet_{K}(θₘ|β) in Formula 10 becomes LogisticNormal_{K}(θₘ|μ, Σ). Simply put, CTM's Σ parameter represents the correlation between pairs of MIS-industries, which allows direct modeling of similar, yet distinct MIS-industries within a single model. Such a framework is more representative of the real world, as the orthogonality of the LDA Dirichlet can lead to cases of greedy inference in which a firm only ends up associated with one of its two industries rather than both in the posterior. FIG. 4B provides a visual summary of CTM.

In certain embodiments, to address the fact that industries dynamically change over time, a Dynamic Topic Model is utilized. The Dynamic Topic Model is a time-series extension of LDA in which we add a stochastic process over the parameters to allow the model to temporally evolve. This evolution is represented with a Kalman Filter, which is a Markov Process (in which time t only depends on time t−1) with Gaussian noise for some fixed variance σ²∈R₊ as:

$${α}_{t} ∼ Normal ( {α}_{t} \vert {α}_{t - 1} , {σ}_{α}^{2} I )$$

$${β}_{t} ∼ Normal ( {β}_{t} \vert {β}_{t - 1} , {σ}_{β}^{2} I )$$

The same normalizing transformation used in CTM is used to ensure the new variable is also a well-defined simplex. The temporal evolution of a and p is visually represented in FIG. 4C (suppressing the t subscripts within the plates for readability). While this architecture effectively captures temporal changes backtesting may be an issue as it models all time-slices simultaneously, implicitly introducing potential look-ahead bias. This is an issue in which the parameters at time t₁ are optimized given information for some t₂ in the future (i.e., t₁<t₂). In certain embodiments, to address this issue, MIS fits a sequence of LDA models that utilize a similar Markov parameter process, such that it avoids looking into the future during inference. For this at time t,

$${α}_{t , k}^{0}$$

denotes the prior parameter and

$${α}_{t , k}^{*}$$

denotes the posterior parameter (i.e., last year's posterior is this-year's prior). The LDA generative process at time t is modified to be a function of a LDA model trained at time t−1 so that Formula 14 is written as

$${ϕ}_{k} ∼ {Dirichlet}_{V} ( {ϕ}_{t , k} \vert {α}_{t - 1 , k}^{*} )$$

This creates a path-dependent process in which the systems and methods propagate information forward and allow the designation of the industry designations to evolve over time. In certain embodiments, to avoid overfitting to the past, the systems and method may apply a simple transform like f(x)=x^{0.5} to

$${α}_{t - 1 , k}^{*}$$

to make it closer to a uniform distribution, which dilutes the prior and allows the new data to have a stronger influence on the posterior.

In certain embodiments, the systems and methods disclosed herein may all be used to create a single ensemble model. Such embodiments may include the following process:
1. For year=1, independently fit S-many HDP models to “discover” MIS-industries. These models are fit with uninformative priors, identical hyperparameters, but different random seeds. Then ensemble together all posteriors by retaining MIS-industries that appear in sufficiently many ensemble members, which mitigates the risk of spurious identification.
2. For year=1, fit an LDA model using the Empirical Bayes prior that is constructed from the HDP ensemble, where K equals the number of all non-trivial MIS-industries discovered in the first step.
3. For year=t, fit an LDA model using a strong prior which is based on the posterior of the previous year's model, allowing for a temporal evolution of the existing MIS-industries.
4. For year=T (the current year), adjust the estimated industry-mixtures from the final LDA model to account for correlated and hierarchical industry relationships to obtain the final MIS-industry relevances for each firm.
   This process is summarized in FIG. 4D.

In utilizing the above referenced models the MIS is adapted to:
Infer the number of MIS-industries K from the data by utilizing Bayesian Non-Parametrics.
Mitigate numerical instability by utilizing an ensemble to get an Empirical Bayes prior.
Temporally evolve our MIS-industries by utilizing a Markov parameter process.
Directly account for correlated/hierarchical topics.
   Indeed, the disclosed architecture has been found to be highly numerically stable and robust to small amounts of noise in the data (assuming the data has been appropriately pre-processed, as discussed above). Though this is an elaborate network of models, each component can be analyzed independently, making it highly human-interpretable and allowing for robust model risk management in practice.

While the above-described models offer a principled approach to modeling uncertainty and making inferences, they can be extremely computationally intensive, especially for complex models or large datasets, as is the case here. As a result, techniques such as Gibbs sampling, Markov chain Monte Carlo (MCMC), and variational inference may be used to approximate posterior distributions. Simply put, the disclosed Bayesian learning theory utilized by a processor provides a flexible and principled framework for reasoning under uncertainty, allowing for the integration of prior knowledge with observed data by the processor to make informed decisions and predictions at set intervals or even in real time.

In certain embodiments, Gibbs Sampling may be used, as it is mechanically transparent and provides useful intuitions for understanding how the optimal solution is obtained. Gibbs Sampling is a flavor of MCMC, a simulation-based technique that generates a sequence of samples that asymptotically converges to the true posterior. For this algorithm, prior values of α^{prior} and β^{prior} will be previously uploaded to a database by the financial advisor or an employee, contractor, or agent of the financial advisor. These can either be set to constant values (producing a symmetric prior), or calibrated by the financial advisor or an employee, contractor, or agent of the financial advisor to coerce the emergence of certain topics. Further, the financial advisor or an employee, contractor, or agent of the financial advisor must also specify the number of industries K and the total number of samples S.

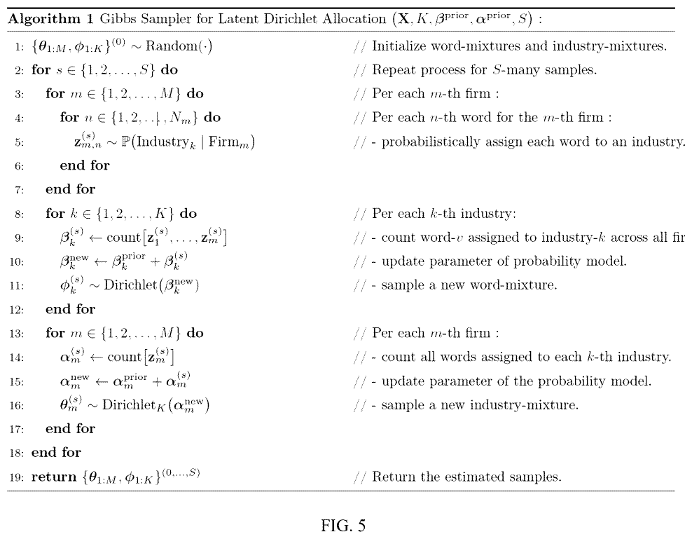

An exemplary embodiment of the system disclosed herein is shown in FIG. 5. In certain embodiments, the first S* may be discarded. In other embodiments, the first S* may take the mean of the remainder as the best estimate for the optimal value. Regardless fitting such a model as depicted in FIG. 5 involves summing the number of words assigned to each industry, and then iteratively re-calibrating until the processor arrives at a stable solution. In general, higher values for S and S* yield a better model, and in practice the only limitation to convergence and the speed to convergence is processing power. In embodiments, such as that depicted in FIG. 5, text pre-processing is the primary mechanism for influencing the optimal solution of this model.

### EXAMPLES

As outlined herein, the systems and methods disclosed herein provide the following advantages over the current state of the art: (1) scalability—humans, regardless of the number working on the problem, cannot reasonably replicate the results of the systems/methods disclosed herein within the required temporal window (i.e., there is too much data to process within the finite “real-time” window required; (2) auditability—this is a clear-box solutions so when there is a fail state the root cause of the fail state can be identified and avoided in the future; and (3) adaptability—the incorporation of personalized guardrails ensures the creation of a unique portfolio that can personalized to target nuanced industries within a designated and known risk band.

### Neighbor Evaluations—3 Firms

With the disclosed systems and methods in mind, consider a collection of hypothetical preliminary dataset for three fictional firms having the below identified dispersion: (1) Nile, (2) Tallmart, and (3) CloudFilms.
Nile={“retail”, “cloud”, “movie”, “movie”, “retail”, “cloud” }
Tallmart={“retail”, “retail”, “store” }
CloudFilms={“movie”, “cinema”, “web-app”, “cloud” }

A financial advisor has previously uploaded the following keyword/industry relationships where K=3

$$Retail : {ϕ}_{1} = P ( word \vert industry = 1 ) = [ {\underbrace{0.01}}_{cinema} {\underbrace{0.02}}_{cloud} {\underbrace{0.01}}_{movie} {\underbrace{0.61}}_{retail} {\underbrace{0.33}}_{store} {\underbrace{0.02}}_{web - app} ]$$

$$Movie : {ϕ}_{2} = P ( word \vert industry = 2 ) = [ {\underbrace{0.31}}_{cinema} {\underbrace{0.01}}_{cloud} {\underbrace{0.64}}_{movie} {\underbrace{0.02}}_{retail} {\underbrace{0.01}}_{store} {\underbrace{0.01}}_{web - app} ]$$

$$Tech : {ϕ}_{3} = P ( word \vert industry = 3 ) = [ {\underbrace{0.02}}_{cinema} , {\underbrace{0.45}}_{cloud} , {\underbrace{0.02}}_{movie} , {\underbrace{0.02}}_{retail} , {\underbrace{0.01}}_{store} , {\underbrace{0.48}}_{web - app} ]$$

As can be seen above, the names of the topics are intuited from the maximal values of each distribution. Retail is dominated by “retail” and “store”, movie is dominated by “movie” and “cinema”, and tech is dominated by “cloud” and “web-app”. Functionally, all of the other values can be ignored, as they are arbitrarily small.

The keyword industry relationships are applied to the preliminary dataset to create the following model input dataset.

$${θ}_{1} = P ( industry \vert firm = Nile ) = [ {\underbrace{0.34}}_{Retail} {\underbrace{0.33}}_{Movie} {\underbrace{0.33}}_{Tech} ]$$

$${θ}_{2} = P ( industry \vert firm = Tallmat ) = [ {\underbrace{0.98}}_{Retail} {\underbrace{0.01}}_{Movie} {\underbrace{0.01}}_{Tech} ]$$

$${θ}_{3} = P ( industry \vert firm = CloudFilms ) = [ {\underbrace{0.01}}_{Retail} {\underbrace{0.66}}_{Movie} {\underbrace{0.33}}_{Tech} ]$$

Within this simplified three-industry example, it can be seen that Nile is a conglomerate with membership dispersed, across multiple industries, while Tallmart is a pure play with membership concentrated in only one. Cloud-Films is in the middle. Furthermore, this also demonstrates that Tallmart is more similar to Nile than it is to CloudFilms, on the basis of text-similarity. In certain embodiments, there could be over a hundred, or even a thousand, firms/corporations in the synthetic universe, each business description could have several thousand words, and the number of industries could be over 100. Indeed, the system and methods may be monitoring over 4000 firms that have at least 15 relevant documents the comply with relevant guardrails uploaded by a financial advisor or an employee, contractor, or agent of the financial advisor over at least three years.

### Industry Evaluation—Single Firm

Another example of how the systems and methods disclosed herein apply to analyze a single firm/company is discussed below. The firm/company selected for this example is Tesla®. In this example, data is first culled from two sources that meet guardrails previously uploaded to a database by a financial advisor or an employee, contractor, or agent of the financial advisor: (1) a business description; and (2) an informal earnings call transcript. The sources state:
Source 1: Tesla is an electric vehicle manufacturer with self-driving EV technology and the first car in space.
Source 2: “Elon is excited about autonomous electric cars, spaceships, and dinosaurs”

The sources are subject to pre-processing to identify specific keywords and key phrases linked—bolded above—to relevant industry groups wherein the keywords and key phrases have been previously uploaded by the financial advisor or an employee, contractor, or agent of the financial advisor. The keywords and key phrases are identified.

In certain embodiments, the identified words may be displayed to the financial advisor or an employee, contractor, or agent of the financial advisor. This display provides easy auditability and risk management tool as the highlighted text can be easily reviewed by the financial advisor or an employee, contractor, or agent of the financial advisor to identify which words are not utilized which may permit the financial advisor or an employee, contractor, or agent of the financial advisor to amend guardrails related to threshold word use and which words may be added/subtracted from relevant semantic trees. Furthermore, the systems and methods return the results within a reasonable timeframe—something humans cannot do.

Next the regular text is dropped and semantic trees previously uploaded to the database by the financial advisor or an employee, contractor, or agent of the financial advisor are applied to the bolded language. For example, “electric vehicle” “autonomous”, and “electric cars” may all be linked to the industry of “EV”, “self-driving” may be linked to “AI”, and “space” and “spaceship” may be linked, resulting in the following preliminary dataset:
Source 1: [“EV”, “AI”, “EV”, “space”]
Source 2: [“AI”, “EV”, “space”, “dinosaurs”]
   By discarding unused words and reducing vocabulary size, the system and method can preform the necessary functions within the compressed temporal window designed by the financial advisor or an employee, contractor, or agent of the financial advisor. Again, the list of key phrases is easily auditable. Furthermore, in certain embodiments, the financial advisor or an employee, contractor, or agent of the financial advisor may subject the text processing to guardrails related to word density (e.g., references only used once in the documents may be discarded). As a result, “dinosaurs” may be discarded.

In this example, the non-parametric topic model has identified three industries: (1) EV, (2) AI, and (3) space. Using non-parametric models to identify reasonable industries guards against naïve word identification (e.g., dinosaurs). Furthermore, the processing can be accomplished within designated temporal windows and create an easily auditable cluster for analysis by the financial advisor or an employee, contractor, or agent of the financial advisor if an audit is required.

In certain embodiments multiple non-parametric topic models previously uploaded by the financial advisor or an employee, contractor, or agent of the financial advisor can be used where each model is previously assigned a trust weight by the financial advisor or an employee, contractor, or agent of the financial advisor. These multiple models may come to different conclusions as to the identified industries with the average—based on the assigned trust weights, if any—used to arrive at the final model input dataset.

The final model input dataset is then converted to a probability distribution, which is a collection of vectors that sum to 100% as depicted below:
Source 1: [“EV” 50%, “AI” 25%, “space” 25%]
Source 2: [“AI” 33%, “EV” 34%, “space” 33%]
   In certain embodiments each probability vector may have no more than 10 industries. In others it is as low as 5. This makes the system and method extremely easy to analyze/audit by the financial advisor or an employee, contractor, or agent of the financial advisor even though thousands of documents were processed in only a minute or two. Furthermore, guardrails related to industry density (e.g., industries that appear less than 5% of the time for a given firm/company) may be applied to the final model input data before converting the dataset to a probability distribution.

Probability distributions from multiple models may also be combined to create a single merged vector. Again, guardrails related to weighting of different models may be applied. This type of model voting/blending may result in an ensemble vector:
Blend: [“EV” 60%, “AI” 40%]
   Such blending significantly reduces the possibility of false positives (i.e., irrelevant industries).

Correlation adjustments, where correlated industries are modified based on guardrails previously uploaded by the financial advisor or an employee, contractor, or agent of the financial advisor are then applied to the ensemble vector. As a result, the correlation adjustment may result in the following vector for Tesla®:
Blend: [“EV” 100%, “AI” 100%]
   It should be noted that such correlation adjustments may result in vectors that sum to more than 100%.

Finally hierarchical adjustments where sub-industries are tied to super-industries based on guardrails previously uploaded by the financial advisor or an employee, contractor, or agent of the financial advisor may occur. For example, because “EV” is linked to “automobiles” the hierarchical adjustment may result in the following vector for Tesla®:
Blend: [“EV” 100%, “AI” 100%, “Automobile” 100%]

As can be seen, if any fail state occurs, the financial advisor or an employee, contractor, or agent of the financial advisor can easily decern the root of the failure—this is a clear box as opposed to black box. Furthermore, auditing can be made easy and efficient via the inclusion of two metrics. First, a model confidence score, which is a score assigned to each firm/company that may be from 0 to 1 which indicates the probability of a false negative for that firm/company. The model confidence score may be based on: (1) document length—shorter documents produce a higher likelihood of missing an important industry; (2) document utilization—a higher number of unlinked thematic words in a document indicates a higher probability that a relevant industry has been missed; and (3) ensemble disagreement—where the less similarity between sources results in a higher likelihood of missing an important industry. Second, out-of-sample prediction may be used, which again may be quantified as a number from 0 and 1. If the model works then it should be able to predict future stock correlations based on sub-industries. Thus, to improve the models a financial advisor or an employee, contractor, or agent of the financial advisor can simply audit the firms with the lowest model confidence and lowest out of sample prediction scores, identify potential gaps/mistakes, and update the guardrails accordingly.

### Improvements Over Prior Art

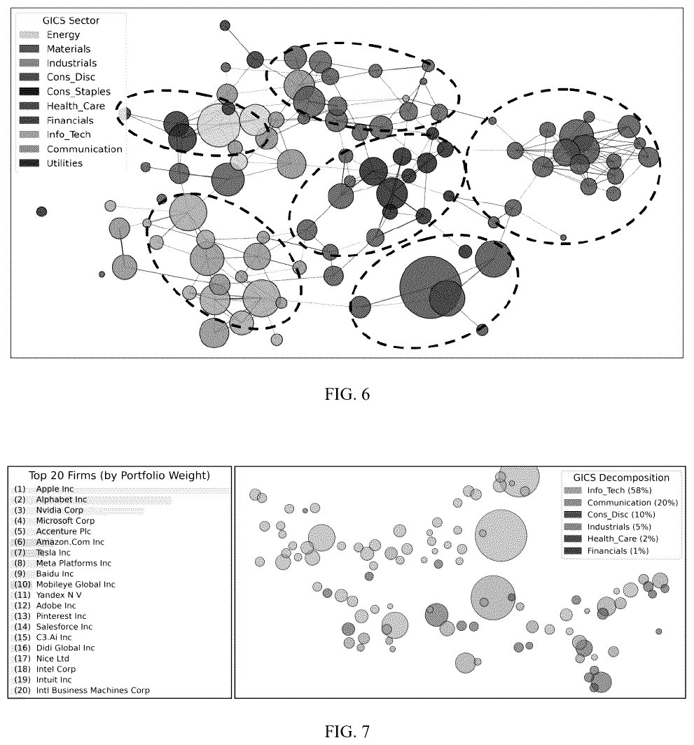

FIG. 6 shows one embodiment of an industry network created using the disclosed system or method colored by the relevant corporation's GICS sector designation. Each of the ninety-seven nodes indicate a specific industry group assigned as described above. The lines connecting circles indicate association between the nodes.

FIG. 6 was created utilizing a universe of over 5000 firms, which the system and method broke out over 97 distinct industries. What is illustrated in FIG. 6 is just a single embodiment of what the industry assignment process described herein can look like, and different choices in data sourcing and semantic tree construction by the financial advisor or an employee, contractor, or agent of the financial advisor will yield varying outputs. Node size is proportionate to probability of incidence and color corresponding to the most common GICS-sector of firms within that MIS-industry. An edge between two nodes indicates that two industries have non-trivial co-occurrence, meaning that these industries are linked within the data.

Within FIG. 6, “sectors are clearly observable. For example, one can see a “sector” of health-oriented firms, a “sector” of finance-related firms. However, other sectors are more nuanced (and perhaps a more realistic) representation of how industries relate to one another in a market. The abundance of edges between nodes highlights just how interconnected various industries are, which shouldn't be surprising from an economic standpoint.

To best highlight the improvements of the disclosed system and methods and GICS, it is helpful to illustrate several collections of industries identified by the described system that are intended to evoke the structure of GICS-sectors. First, consider the following nuanced commodity related industry designations identified by the disclosed system and method in Table 1, with the top three associated keywords identified as disclosed herein.

TABLE 1
Subset of Commodities Industries

| | | | |
|---|---|---|---|
| OIL DRILLING: | “oil-drilling” (82%) | “gas-pipeline” (9%) | “fracking” (7%) |
| METAL: | “metal” (46%) | “ferrous” (37%) | “nonferrous” (14%) |
| WOOD: | “wood” (64%) | “timber” (27%) | “lumber” (10%) |
| MEAT: | “meat” (49%) | “red-meat” (18%) | “poultry” (16%) |
| MARIJUANA: | “marijuana” (54%) | “cannabis” (44%) | “t.h.c.” (2%) |

While the first four industries identified in Table 1 have direct analogues to GICS-industries, marijuana does not—it is completely unrepresented in GICS. As a result, the disclosed system and methods identifies more nuanced industry sectors.

The difference in the healthcare designations shows, again, how the disclosed system and methods provide a more nuanced approach than GICS. Consider the industries identified in Table 2 below.

TABLE 2
Subset of Healthcare Industries

| | | | |
|---|---|---|---|
| CARDIOLOGY: | “cardiology” (65%) | “heart-attack” (22%) | “heart” (11%) |
| ONCOLOGY: | “oncology” (85%) | “carcinoma” (10%) | “lymphoma” (9%) |
| MICROBIOLOGY: | “microbiology”(58%) | “virology” (18%) | “bacteriology” (15%) |
| GENOMICS: | “genomics” (66%) | “gene-editing” (23%) | “d.n.a.” (10%) |
| SURGERY: | “surgery” (72%) | “organ-transplant” (17%) | “orthopedics” (12%) |

Unlike GICS, which simply partitions all of healthcare into broad categories like biotechnology and pharmaceuticals, the disclosed systems and methods are able to leverage the specificity of medical language to identify precisely which areas of health a firm is working in, providing a much richer description of the relevant sub-industries.

As a final example, consider some of the technology industries that the disclosed systems and methods identified:

TABLE 3
Subset of Technology Industries

| | | | |
|---|---|---|---|
| A.I.: | “artificial-intelligence” (60%) | “computer-vision” (23%) | “n.l.p.” (15%) |
| STREAMING: | “media-streaming” (49%) | “television” (21%) | “music-streaming” (14%) |
| BLOCKCHAIN: | “blockchain” (56%) | “cryptocurrency” (44%) | — |
| ROBOTICS: | “robotics” (59%) | “factory-automation” (31%) | — |
| CAD: | “c.a.d.” (52%) | “3d-print” (48%) | — |

Here, we are again, the disclosed system and methods were able to construct industries that are completely unrepresented in GICS. In addition, it should be noted that the emergence of these precise industries is a function of the text sources and pre-processing choices made by the financial advisor or an employee, contractor, or agent of the financial advisor. Richer input text and more elaborate pre-processing can lead to more nuanced topics, and these exemplary embodiments are for illustrative purposes.

### Portfolio Construction

The disclosed systems and methods can be used to identify and construct neighbor firms on the basis of text. In certain embodiments, Hellinger similarity is used as a “correlation” measure between the descriptions of two firms as outlined in Formula 15 below:

$$similarity ( {firm}_{i} , {firm}_{j} ) = 1 - \frac{1}{\sqrt{2}} ‖ \sqrt{{θ}_{i}} - \sqrt{{θ}_{j}} ‖ \qquad Formula 15$$

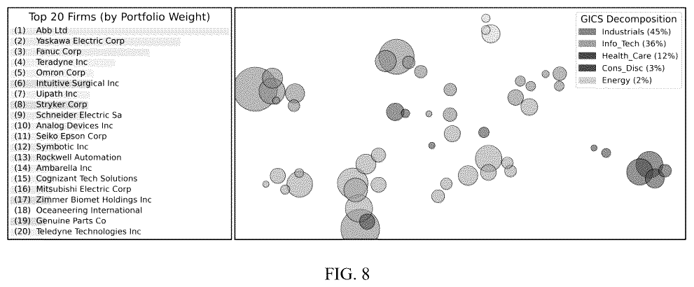

FIG. 7 depicts a non-limiting illustrative example that identifies 20 Amazon® neighbors with a Hellinger similarity greater than 0.25, (sorted by size). Each node represents one of these neighboring firms, where color corresponds to GICS sector and size corresponds to firm size. Again, an edge between nodes indicates that two firms are “neighbors”.

The disclosed systems and methods identified four major industries that Amazon® is a part of: retail, cloud computing, media streaming, and artificial intelligence. Amazon's largest neighbors span four GICS sectors—information technology, communications services, consumer discretionary, and consumer staples—highlighting its high level of diversification and obvious misrepresentation risk that results when one adds Amazon® using only the current GICS approach.

Another demonstration of the nearest neighbor capabilities of the disclosed systems and methods is Apple®. FIG. 8 depicts a non-limiting illustrative example that identifies 20 Apple® neighbors with a Hellinger similarity greater than 0.25, (sorted by size). Again, each node represents one of these neighboring firms, where color corresponds to GICS sector and size corresponds to firm size. Also, again, an edge between nodes indicates that two firms are “neighbors”. Again, the disclosed systems and methods are able to identify four major industries for a highly diversified firm: consumer tech, artificial intelligence, media streaming, and payment technology. As with Amazon®, the nearest neighbor list similarly represents multiple GICS sectors.

The disclosed systems and methods are also capable of constructing thematic portfolios, which have been popular in recent years as a means of investing in innovative technologies. These thematic portfolios are constructed by identifying all firms with a probability of inclusion in an industry (aka “theme”) exceeding 5%. The portfolio weight is a function of firm size (si) and probability of inclusion, defined by the following Formula 16:

$${w}_{i} ∝ \sqrt{{s}_{i}} \cdot P ( industry \vert {firm}_{i} ) \qquad Formula 16$$

FIG. 7 depicts an artificial intelligence portfolio constructed using the disclosed systems or methods. Again, each nodes represents a firm, where color corresponds to GICS sector and node size corresponds to firm size. The positions of the nodes are determined by t-distributed Stochastic Neighbor Embedding (“t-sne”), which is a dimensionality reduction technique commonly used in machine learning for visualizing high-dimensional data in lower-dimensional space, typically two or three dimensions, while preserving the pairwise similarities between data points as much as possible.

As can be seen in FIG. 7, the ten largest firms represent three sectors, highlighting just how sector-agnostic artificial intelligence really is. Beyond that, the long tail of smaller names also includes firms in industrials, healthcare, and financials. Simply put, the disclosed systems and methods produced a thematic AI-portfolio that would not be possible to construct using GICS.

Another example of a thematic portfolio constructed using the disclosed systems and methods is the Robotics portfolio depicted in FIG. 8. As above, this portfolio represents multiple GICS sectors, including a cluster of surgical robots (healthcare), oil drilling robots (energy), industrial robots, and several firms in information technology. Without a tool like those disclosed herein, one could not construct such a portfolio tailored thematic portfolio, thus highlighting the significant utility of the systems and methods described herein for investors who want to allocate to emerging industries.

System Interaction with Users

In certain embodiments, a constraint linked to each portfolio may be uploaded to the database by a financial advisor or an employee, contractor, or agent of the financial advisor. Examples of such constraints are industries, nearest neighbors of designated firms, or target environmental, social, and governance (ESG) scores. In certain embodiments, the financial advisor or an employee, contractor, or agent of the financial advisor. may designate a minimum relationship between holdings that they wish for the portfolio to maintain. In such embodiments, the processor may not only seek to maximize the portfolio's probability of obtaining the desired industry, but also seek to maximize the relatedness of the portfolio's holdings.

In certain embodiments, the system includes guardrails. Such guardrails may prevent conservative investors, who may have aggressive goals, from taking on too much risk. In such an embodiment, holdings are categorized into groups based on the omnibus risk profile determined by the disclosed systems and methods. In addition, a guardrail factor for each classification may be uploaded by a financial advisor or an employee, contractor, or agent of the financial advisor. Such a guardrail factor may be numeric (e.g., from 0 and 100) and will restrict how much risk any portfolio may include. By restricting risk of the portfolio, the guardrail factor restricts the amount of risk the investor may take on.

In other embodiments, the risk classification may be in writing. By way of example, the investors may be classified as “Conservative”, “Moderate” or “Aggressive” depending on their traditional risk appetite. These classifications may coincide with numeric values previously uploaded to the database by the financial advisor or an employee, contractor, or agent of the financial advisor. For example, the guardrails for “Conservative” investors may be 50, for “Moderate” investors may be 75 and there may be no guardrail factor entered for “Aggressive” investors. If there is no guardrail factor uploaded, the investor would have access to the entire range of portfolios. With such guardrail factors in place, “Conservative” investors are restricted to the bottom 50% of the total risk profile. Similarly, “Moderate” investors may proceed up to 75% of the risk profile, and investors classified as “Aggressive” have no restrictions on how far up the risk profile they may proceed.

Simply put the guardrail factor sets the maximum for both the first apportionment factor and second apportionment factor. By way of example, if a “Conservative” investor whose guardrail factor has been set to 50 stated that they wished to pursue a risky strategy which may be up to 80% of the risk profile, the guardrail factor overrides the investor's election and sets the first portfolio to only 50% of the risk profile of the portfolio.

In other embodiments, the guardrail factor may incorporate the investor's selection by using the guardrail factor to set the top end of the investor's range. For example, if a “Conservative” investor whose guardrail factor has been set to 50 stated that they wished to pursue a strategy of 80% up the risk profile, the risk factor may be set to 40 (i.e., 50×0.80=40). In summary, the incorporation of a risk profile provides a check against investors taking on more risk than they may actually be comfortable with.

In other embodiments, the system employs a crash threshold. Such a crash threshold is uploaded to the database by a financial advisor or an employee, contractor, or agent of the financial advisor. The crash threshold may be a numeric value or a technical chart pattern. In certain embodiments, the system continuously monitors and assigns a market risk score based on a number of factors including market capitalization, volatility, and the market's 50-day and 200-day moving averages.

For example, the crash threshold may be set to look for a technical market pattern know as a “death-cross” in the retail sector wherein the 50-day moving average falls below the 200-day moving average. When the system identifies such a technical pattern, the system may automatically reduce the portfolio's risk by moving the portfolio's holdings of retail risk down. Conversely, if the crash threshold is breached, the system may move all the investor's portfolio holdings in retail to “Risk Off” portfolios which are a parallel set of portfolios uploaded to the database by a financial advisor or an employee, contractor, or agent of the financial advisor which are created specifically to protect against a market crash. This shift is over and above any pre-determined reallocation schedules and is more an event-based trigger. The system then stays put on these “Risk Off” portfolios till the market passes back through the crash threshold a second time, indicating the possibility of a market crash has subsided. Again, the crash threshold is subjective and may be transmitted by the investor via the software application or uploaded to the database by a financial advisor or an employee, contractor, or agent of the financial advisor.

### System Components

A non-limiting embodiment of the system includes a general-purpose computing device, having a processing unit (CPU or processor), and a system bus that couples various system components including the system memory such as read only memory (ROM) and random-access memory (RAM) to the processor. The system can include a storage device connected to the processor by the system bus. The system can include interfaces connected to the processor by the system bus. The system can include a cache of high-speed memory connected directly with, in close proximity to, or integrated as part of the processor. The system can copy data from the memory and/or a storage device to the cache for quick access by the processor. In this way, the cache provides a performance boost that avoids processor delays while waiting for data. These and other modules stored in the memory, storage device, or cache can control or be configured to control the processor to perform various actions. Other system memory may be available for use as well. The memory can include multiple different types of memory with different performance characteristics.

### Computer Processor

The invention may operate on a computing device with more than one processor or on a group or cluster of computing devices networked together to provide greater processing capability. The processor can include any general-purpose processor and a hardware module or software module, stored in an external or internal storage device, configured to control the processor as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity purposes, an illustrative system embodiment is presented as having individual functional blocks including functional blocks labeled as a “processor.” The functions such blocks represent may be provided through the use of either shared or dedicated hardware, including, but not limited to, hardware capable of executing software and hardware, such as a processor, which is purpose-built to operate as an equivalent to software executing on a general-purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, read-only memory (ROM) for storing software performing the operations discussed in this document, and random-access memory (RAM) for storing results. Very large-scale integration (VLSI) hardware embodiments, as well as custom VLSI circuitry in combination with a general-purpose DSP circuit, may also be provided.

### System Bus

The system bus may be any of several types of bus structures including a memory bus or memory controller, a peripheral bus, and a local bus using any of a variety of bus architectures. A basic input/output system (BIOS) stored in ROM or the like may provide the basic routine that helps to transfer information between elements within the computing device, such as during start-up.

### Storage Device

The computing device can further include a storage device such as a hard disk drive, a magnetic disk drive, an optical disk drive, a solid-state drive, a tape drive or the like. Similar to the system memory, a storage device may be used to store data files, such as location information, menus, software, wired and wireless connection information (e.g., information that may enable the mobile device to establish a wired or wireless connection, such as a USB, Bluetooth, or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld, computing device, a desktop computer, or a computer server.

Although an embodiment described in this document uses cloud computing and cloud storage, it should be appreciated by those skilled in the art that other types of computer-readable media which can store data that are accessible by a computer, such as magnetic cassettes, flash memory cards, digital versatile disks, cartridges, random access memories (RAMS), read only memories (ROMS), a cable or wireless signal containing a bit stream and the like, may also be used in the operating environment. Furthermore, non-transitory computer-readable storage media as used in this document include all computer-readable media, with the sole exception being a transitory propagating signal per se.

### Interface

To enable user interaction with the computing device, an input device represents any number of input mechanisms, such as a microphone for speech, a web camera for video, a touch-sensitive screen for gesture or graphical input, a keyboard, a mouse, a motion input, and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output and/or communication interface.

There is no restriction on operating on any particular hardware arrangement and therefore the basic features disclosed may easily be substituted for improved hardware or firmware arrangements as they are developed.

### Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor, then these modules may be loaded into RAM or memory at runtime or may be stored as would be known in the art in other computer-readable memory locations. Having disclosed some components of a computing system, the disclosure now turns to a description of cloud computing, which is the preferred environment of the invention.

### Cloud System

Cloud computing is a type of Internet-based computing in which a variety of resources are hosted and/or controlled by an entity and made available by the entity to authorized users via the Internet. A cloud computing system can be configured so that a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

### Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network-enabled computing devices. For example, cloud computing resources can communicate with a server, a database, and/or any other network-enabled computing device to provide the cloud resources.

In some cases, the cloud resources can be redundant. For example, if cloud computing resources are configured to provide data backup services, multiple copies of the data can be stored such that the data are still available to the user even if a storage resource is offline, busy, or otherwise unavailable to process a request. In another example, if a cloud computing resource is configured to provide software, then the software can be available from different cloud servers so that the software can be served from any of the different cloud servers. Algorithms can be applied such that the closest server or the server with the lowest current load is selected to process a given request.

### User Terminal

A user interacts with cloud computing resources through user terminals or testing devices connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. In other cases, however, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

### Service Models

Cloud computing resources can provide cloud resources to user terminals through a variety of service models, such as Software as a Service (SaaS), Platforms as a Service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

### User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or databases.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of the cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

### Collection Of Data

In some configurations, during the creation or maintenance of the portfolio described above, a storage device or resource can be used to store relevant data. Examples of the data contemplated for storage are user personal data, location data, and employment data. The data stored can be incorporated into the disclosed system and methods used to refine the efficient frontier 400 to adjust for asymmetric goals such as tax issues and restrictions on the investor's holding options based on employment status. In addition, collected data may be used for single command responses to update inquiries propounded by the system in response to a personal or market-driven event (e.g., the investor loses their job, or the market drops 5%).

### User Personal Data

The invention contemplates that, in some instances, this gathered data might include user personal and/or sensitive data. The invention further contemplates that the entities responsible for the collection, analysis, disclosure, transfer, storage, or other use of such data should implement and consistently use privacy policies and practices that are generally recognized as meeting or exceeding industry or governmental requirements for maintaining personal information and keeping data private and secure. For example, personal data from users should be collected for legitimate and reasonable uses of the entity and not shared or sold outside of those legitimate uses. Further, such collection should occur only after the informed consent of the users. In addition, such entities should take any needed steps to safeguard and secure access to such personal data and ensure that others with access to the personal data adhere to their privacy and security policies and procedures. Further, such entities can subject themselves to evaluation by third parties to certify their adherence to widely accepted privacy policies and practices.

### User Opt-Out

Despite the foregoing, the invention also contemplates embodiments in which users selectively block the use of, or access to, personal data. That is, the invention contemplates that hardware and/or software elements can be provided to prevent or block access to such personal data. For example, the present technology can be configured to allow users to select the data that are stored in cloud storage. In another example, the present technology can also be configured to allow a user to specify the data stored in cloud storage that can be shared with any advisors or third-party financial institutions.

Therefore, although the invention broadly covers use of personal data to implement one or more various disclosed embodiments, the invention also contemplates that the various embodiments can also be implemented without the need for accessing such personal data. That is, the various embodiments of the present technology are not rendered inoperable due to the lack of all or a portion of such personal data.

While this subject matter has been disclosed with reference to specific embodiments, it is apparent that other embodiments and variations can be devised by others skilled in the art without departing from the true spirit and scope of the subject matter described herein.

What is claimed is:

1. A system for constructing and dynamically maintaining a fund, the system comprising:
a software application, the application operating on a mobile computer device or on a computer device, which is in communication with a financial advisor or an employee or agent of the financial advisor, wherein the application is configured to receive the following subject information from the financial advisor or an employee or agent of the financial advisor: (a) a list identifying holdings of the fund, and (b) a target industry mixture for the fund, wherein, the software application is further configured to communicate the subject information through a wired and/or wireless communication network to a server located at a site where financial advisor or an employee or agent of the financial advisor is physically present or at a location remote from the site; and
a processor that is in communication through the wired and/or wireless communication network with the software application, as well as the server, the processer is configured to recall from a database of the system, upon communication of the subject information to the server: (a) document search strategies, (b) a text pre-processing protocol, (c) a topic modeling protocol, and (d) a post-processing protocol, wherein the document search strategies, test pre-processing protocol, topic modeling protocol, and post-processing protocol were previously uploaded to the database by a financial advisor or an employee, contractor, or agent of the financial advisor;
whereby the processor identifies and links relevant documents to individual holdings of the fund using the document search strategies
whereby the processor highlights keyphrases within the linked documents using the text pre-processing protocol;
whereby the processor determines an industry designation to each of the holdings of the fund based on the topic modeling protocol as applied to the keyphrases;
whereby the processor determines a cumulative industry designation based on the holdings of the fund;
whereby when the cumulative industry designation based on the holdings of the fund does not equal the target industry mixture within a range of tolerance, the processor constructs or adjusts the holdings of the funds to align with the target industry mixture.

2. The system according to claim 1 wherein, the document search strategies are location-based, document-based, author-based, or a combination thereof.

3. The system according to claim 1 wherein, the document search strategies include trust-weighting(s).

4. The system according to claim 1 wherein, the text pre-processing protocol uses a human-in-the-loop workflow.

5. The system according to claim 4 wherein, the text pre-processing protocol uses: (1) normalization, (2) stemming, (3) n-gram construction, (4) stop-word removal, (5) lemmatization, or (6) combinations thereof.

6. The system according to claim 1 wherein, the text pre-processing protocol is adapted to identify and count the number of keywords using a permutation-invariant multiset of words to create a model-input dataset.

7. The system according to claim 1 wherein, the text pre-processing protocol is adapted to uses within-document context to create a model input dataset.

8. The system according to claim 1 wherein, the topic modeling protocol uses Bayes learning theory.

9. The system according to claim 1 wherein, the topic modeling protocol uses an ensemble machine learning architecture adapted to leverage multiple topic models and convert keywords, identified by the text pre-processing protocol, into industry-membership probabilities.

10. The system according to claim 1 wherein, the post-processing protocol is further adapted to adjust the holdings of the funds based on correlations and hierarchical relationships between industries previously uploaded to the database by a financial advisor or an employee, contractor, or agent of the financial advisor.

11. A method for constructing and dynamically maintaining a fund, the method comprising:
receiving the following desired industry profile that has been provided by a financial advisor or an employee, contractor, or agent of the financial advisor using a software application operating on a mobile computer device or a computer device that is synchronized with the mobile computer device: (a) a list identifying holdings of the fund, and (b) a target industry mixture for the fund, whereby the mobile computer device and the computer device communicate with a remote server of the system located at a site where an advisor is physically present or at a location remote from the site through wired and/or wireless communication networks;
upon receiving the desired industry profile in the system, calling up: (a) document search strategies, (b) a text pre-processing protocol, (c) a topic modeling protocol, and (d) a post-processing protocol, wherein the document search strategies, test pre-processing protocol, topic modeling protocol, and post-processing protocol were previously uploaded to the database by a financial advisor or an employee, contractor, or agent of the financial advisor;
identifying relevant documents to individual holdings of the fund using the document search strategies;
linking relevant documents to individual holdings of the fund using the document search strategies;
highlighting keyphrases within the linked documents using the text pre-processing protocol;
determining an industry designation to each of the holdings of the fund based on the topic modeling protocol as applied to the keyphrases;
determining a cumulative industry designation based on the holdings of the fund;
constructing or adjusting the holdings of the fund so that the cumulative industry designation based on the holdings of the fund equals, within a range of tolerance, the target industry mixture.

12. The method according to claim 11 wherein, the document search strategies are location-based, document-based, author-based, or a combination thereof.

13. The method according to claim 11 wherein, the document search strategies include trust-weighting(s).

14. The method according to claim 11 wherein, the text pre-processing protocol uses a human-in-the-loop workflow.

15. The method according to claim 14 wherein, the text pre-processing protocol uses: (1) normalization, (2) stemming, (3) n-gram construction, (4) stop-word removal, (5) lemmatization, or (6) combinations thereof.

16. The method according to claim 11 wherein, the text pre-processing protocol is adapted to identify and count the number of keywords using a permutation-invariant multiset of words to create a model-input dataset.

17. The method according to claim 11 wherein, the text pre-processing protocol is adapted to uses within-document context to create a model input dataset.

18. The method according to claim 11 wherein, the topic modeling protocol uses Bayes learning theory.

19. The method according to claim 11 wherein, the topic modeling protocol uses an ensemble machine learning architecture adapted to leverage multiple topic models and convert keywords, identified by the text pre-processing protocol, into industry-membership probabilities.

20. The method according to claim 11 wherein, the post-processing protocol is further adapted to adjust the holdings of the funds based on correlations and hierarchical relationships between industries previously uploaded to the database by a financial advisor or an employee, contractor, or agent of the financial advisor.
